(19) United States
(12) Patent Application Publication
(10) Pub. No.: US 2010/0123586 A1
(43) Pub. Date: May 20, 2010

(54) RFID TAG AND MANUFACTURING METHOD OF RFID TAG

(75) Inventors: Shunji Baba, Kawasaki (JP); Shigeru Hashimoto, Inagi (JP); Yoshiyasu Sugimura, Inagi (JP); Tsuyoshi Niwata, Inagi (JP); Satoru Nogami, Inagi (JP); Toru Maniwa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU FRONTECH LIMITED, Tokyo (JP)

(21) Appl. No.: 12/646,409

(22) Filed: Dec. 23, 2009

Related U.S. Application Data
(63) Continuation of application No. PCT/JP2007/063437, filed on Jul. 5, 2007.

(51) Int. Cl. G08B 13/14; B29C 65/70

(52) U.S. Cl. 340/572.8; 156/245

(57) ABSTRACT

The present invention relates to a RFID (Radio Frequency IDentification) tag for exchanging information with an external device in a non-contact manner, and aims to provide a RFID tag having an external shape of a belt, which fits articles made of various kinds of materials. The RFID tag includes: an inlay having an antenna and a circuit chip incorporating a communication circuit for wireless communications via the antenna, an enclosure that encloses the inlay, a flexible belt that surrounds an article to attach the enclosure to the article, and a spacer fixed to a surface of the enclosure on the article side, deforming in response to deformation of the belt to maintain a spacing between the article and the enclosure.

### CROSS-REFERENCE TO RELATED APPLICATION

This is a continuation application of PCT/JP2007/063437, filed on Jul. 5, 2007.

### TECHNICAL FIELD

The present invention relates to a RFID (Radio Frequency IDentification) tag that exchanges information with an external device in a non-contact manner and a manufacturing method of the RFID tag.

### BACKGROUND ART

In recent years, there are proposed various types of RFID tag that exchanges information by radio waves in a non-contact manner with an external device represented by a reader-writer (see Japanese Laid-open Patent Publication Nos. 2000-311226, 2000-200332 and 2001-351082, for example).

FIG. 1 is a schematic cross-sectional diagram illustrating one example of an inner component member (inlay) constituting a RFID tag.

An inlay 10 for a RFID tag in FIG. 1 is formed such that on an antenna base 11 made of, for example, PET film or the like that can bend, an antenna 12 made of a conductive pattern is formed and further a circuit chip 13 is mounted thereon. The circuit chip 13 incorporates a communication circuit for wireless communications with an external device via the antenna 12. The circuit chip 13 is electrically connected to the antenna 12 by connection terminals 13a formed on the under surface of the circuit chip 13 by means of soldering or the like, and its surrounding is fixed to the antenna base 11 with an adhesive 14.

A RFID tag has a structure in which the inlay 10 one example of which is illustrated in FIG. 1 is enclosed inside.

A RFID tag exchanges information by radio waves in a non-contact manner so that when an antenna is brought too closely to metal, a reaching distance of radio waves is lowered or a malfunction occurs. Therefore, there is proposed a technique of providing a spacer to prevent an antenna from approaching metal too closely (see Japanese Laid-open Patent Publication No. 2005-309811, for example).

There is also proposed a RFID tag having an external shape of a belt (band), which is a type surrounding an article to be fixed (see Japanese Laid-open Patent Publication Nos. 01-259881, 2001-236476, 2001-173281, 2007-99484, and Japanese Patent No. 3883896, for example).

Alternatively, other than a belt, Japanese National Publication of International Patent Application No. 2001-516111, for example, proposes a RFID tag provided with a hook to which a string or a rubber band can be attached, for attaching the RFID tag to an article.

According to the above-described belt-type RFID tag, it is easy to attach the RFID tag to a column-shaped article like a cylinder or a tube-shaped article, which is convenient.

However, if the belt-type RFID tag is applied to, for example, a metal pillar or an article that contains a lot of water like a human being, especially in a case of a RFID tag utilizing radio waves in UHF band, there is a possibility that communications may be disabled due to effect of water or metal, or a communication available distance may be considerably shortened. In order to reduce effect of metal and water, there is known a structure in which a spacer is formed by a dielectric material such as plastic. However, it is difficult to accommodate to a column-shaped or a tube-shaped article by a hard spacer like this.

In view of the above circumstances, the present invention aims to provide a RFID tag having an external shape of belt, which can be applied to articles made of various kinds of materials.

### DISCLOSURE OF INVENTION

According to an aspect of the invention, a RFID tag includes:

an inlay having an antenna and a circuit chip incorporating a communication circuit for wireless communications via the antenna;

an enclosure that encloses the inlay;

a flexible belt surrounding an article to attach the enclosure to the article; and

a spacer fixed to a surface of the enclosure on the article side, and deforming in response to deformation of the belt to maintain a spacing between the article and the enclosure.

The spacer may be a single continuous member having flexibility, or may be made up of plural space maintaining members that are disposed spaced apart in a longitudinal direction of the belt and that change shape as a whole by changing postures in response to deformation of the belt.

Either type of the above-described spacers can maintain a spacing effectively between an enclosure in which an inlay is enclosed and an article, by flexibly changing a shape or a posture of the spacers when the belt wraps around the article.

In the RFID tag of the present invention, the belt may be formed integrally with the enclosure, or may be formed separately from the enclosure and detachably attached to the enclosure.

If the belt is formed separately from the enclosure, for example, the enclosure may include a hole to let through the belt and the belt is attached to the enclosure by being inserted into the hole.

By forming a belt integrally, the number of parts is reduced, therefore cutting down on costs is achieved. On the other hand, by forming a belt separately, it is possible to attach the belt having a dimension in accordance with a dimension of an article, enabling flexible accommodation to articles having different dimensions.

In the RFID tag of the present invention, the inlay may include visible information recorded in a part of a surface of the inlay, and the enclosure may include a view window made of a material having light transmission characteristics to recognize the visible information.

By the structure that records a piece of visible information recognized with the eyes on an inlay, for example, by means of such as printing, and includes a view window made of a transparent material in the enclosure, a failure that the piece of visible information fades or disappears is prevented.

In the RFID tag of the present invention, if a spacer made of a continuous member having flexibility is provided as the above-described spacer, preferably the spacer is made of a foam material in which bubbles are dispersed.

Since a foam material includes air inside the spacer, and by the presence of air, it is possible to suppress an actual dielectric rate of the spacer, thereby improving an antenna gain without downsizing the antenna to the extent of unnecessary dimensions.

It is preferable that, if a spacer made of a continuous member having flexibility is provided, a dimension of the spacer is larger than that of the antenna with respect to a longitudinal direction of the belt and the spacer is fixed to a position covering the antenna.

By this, it is possible to maintain a spacing all the more securely between the antenna in the enclosure and the article.

It is also preferable that, if a spacer made of a continuous member having flexibility is provided, the spacer is formed such that rigid members to maintain a spacing between the enclosure and the article are dispersedly arranged in a flexible member.

By arranging rigid members dispersedly in a flexible member, it is possible to surely control a spacing between the enclosure and the article.

It is also preferable that, if a spacer made of a continuous member having flexibility is provided, the spacer includes an adhesion layer to adhere to an article, on a surface on the article side.

This prevents displacement of an attaching position of a RFID tag after the RFID tag is attached to an article, so that a secure attachment is enabled.

In the RFID tag of the present invention, it is preferable that, each of the plural space maintaining members forming the spacer includes a base section fixed to the enclosure and a pair of standing sections standing with respect to the enclosure and bifurcating from the base section into two branches in the longitudinal direction of the belt while widening a gap between the two branches.

If space maintaining members having the above-described shape including the base section and the pair of standing sections are employed, when the RFID tag is attached to an article, stability of the space maintaining members is enhanced and falling off of the space maintaining members is prevented. Additionally, employing the shape including the base section and the pair of standing sections does not impair accommodation to the shape of an attachment portion of an article.

According to another aspect of the invention, a first manufacturing method of a RFID tag, among manufacturing methods of a RFID tag of the present invention, includes:

making an inlay by mounting, on an antenna base on which an antenna is formed, a circuit chip incorporating a communication circuit for wireless communications via the antenna;

making a base including an inlay placement section in which the inlay is placed and a belt section extending from the inlay placement section and surrounding an article to be fixed to the article;

enclosing the inlay by placing the inlay in the inlay placement section of the base, further placing a cover such that the inlay is sandwiched between the cover and the base, and applying heat and pressure, so that an enclosure that encloses the inlay by the base and the cover is formed on the base; and

adhering a spacer that maintains a spacing between the article and the enclosure on a surface of the enclosure on the article side.

According to the above-described first manufacturing method, an enclosure and a belt are integrally formed, and thus a RFID tag of the present invention is manufactured.

According to yet another aspect of the invention, a second manufacturing method of a RFID tag, among manufacturing methods of a RFID tag of the present invention, includes:

making an inlay by mounting, on an antenna base on which an antenna is formed, a circuit chip incorporating a communication circuit for wireless communications via the antenna;

making a base on which the inlay is placed;

enclosing the inlay by placing the inlay in the inlay placement section of the base, further placing a cover such that the inlay is sandwiched between the cover and the base, and applying heat and pressure, so that an enclosure that encloses the inlay by the base and the cover is formed on the base;

molding a belt surrounding an article to attach the enclosure to the article;

forming a hole to let through the belt in the enclosure; and

adhering a spacer that maintains a spacing between the article and the enclosure on a surface of the enclosure on the article side.

According to the above-described second manufacturing method, an enclosure and a belt are separately formed, and thus a RFID tag of the present invention is manufactured.

Both of the first and the second manufacturing methods may further include:

making a spacer in which rigid members are dispersedly arranged in a flexible material, by alternately laminating a sheet member made of a flexible material and plural line members made of a rigid material, which are arranged spaced apart on the sheet member, and by forming a block in which the line members are dispersedly arranged in the flexible material through application of heat and pressure, and then by cutting the block in a predetermined thickness,

wherein the adhering of a spacer adheres the spacer that is made in the making of a spacer.

For example, by further including the above-described making of a spacer, rigid members are dispersedly arranged in a flexible material, and thus a RFID tag of the present invention is manufactured.

The article and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic cross-sectional diagram illustrating one example of an internal composition member (inlay) constituting a RFID tag;

FIG. 2 illustrates a RFID tag of a first embodiment of the present invention;

FIG. 3 is a drawing for explaining dimensions of the RFID tag illustrated in FIG. 2;

FIG. 4 is a drawing for explaining an attaching method of the RFID tag illustrated in FIG. 2;

FIG. 5 is a drawing illustrating a spacing between metal and a RFID tag in UHF band using 953 MHz, and a communication distance of the RFID tag;

FIG. 6 is a drawing illustrating a spacing between water and a RFID tag in UHF band using 935 MHz, and a communication distance of the RFID tag;

FIG. 7 illustrates a RFID tag of a second embodiment of the present invention;

FIG. 8 illustrates a RFID tag of a third embodiment of the present invention;

FIG. 9 illustrates a state in which the RFID tag illustrated in FIG. 6 surrounds an article;

FIG. 10 illustrates a RFID tag of a fourth embodiment of the present invention;

FIG. 11 illustrates a state in which the RFID tag illustrated in FIG. 10 surrounds an article;

FIG. 12 illustrates a RFID tag of a fifth embodiment of the present invention;

FIG. 13 illustrates a RFID tag of a sixth embodiment of the present invention;

FIG. 14 illustrates a RFID tag of a seventh embodiment of the present invention;

FIG. 15 illustrates a state in which the RFID tag illustrated in FIG. 14 surrounds an article;

FIG. 16 illustrates a state in which the RFID tag of the eighth embodiment surrounds an article;

FIG. 17 is a flowchart illustrating one embodiment of a manufacturing method of a RFID tag of the present invention;

FIG. 18 is a drawing for explaining a step of making an inlay;

FIG. 19 is a drawing for explaining a step of making a base;

FIG. 20 is a drawing for explaining a step of enclosing an inlay;

FIG. 21 illustrates a shape after thermo-compression bonding;

FIG. 22 is a drawing for explaining a step of adhering a spacer;

FIG. 23 illustrates a completed RFID tag after a spacer is adhered;

FIG. 24 is a drawing for explaining a manufacturing method of a spacer;

FIG. 25 is a drawing for explaining a manufacturing method of a spacer;

FIG. 26 is a flowchart illustrating another example of a manufacturing method of a RFID tag of the present invention;

FIG. 27 is a drawing for explaining a step of making an inlay;

FIG. 28 is a drawing for explaining a step of making a base;

FIG. 29 is a drawing for explaining a step of enclosing an inlay;

FIG. 30 illustrates a shape after thermo-compression bonding;

FIG. 31 illustrates a belt;

FIG. 32 is a drawing for explaining a step of forming a hole and a step of adhering a spacer; and

FIG. 33 illustrates a completed RFID tag.

### BEST MODE FOR CARRYING OUT THE INVENTION

Embodiments of the present invention will be described with reference to the drawings.

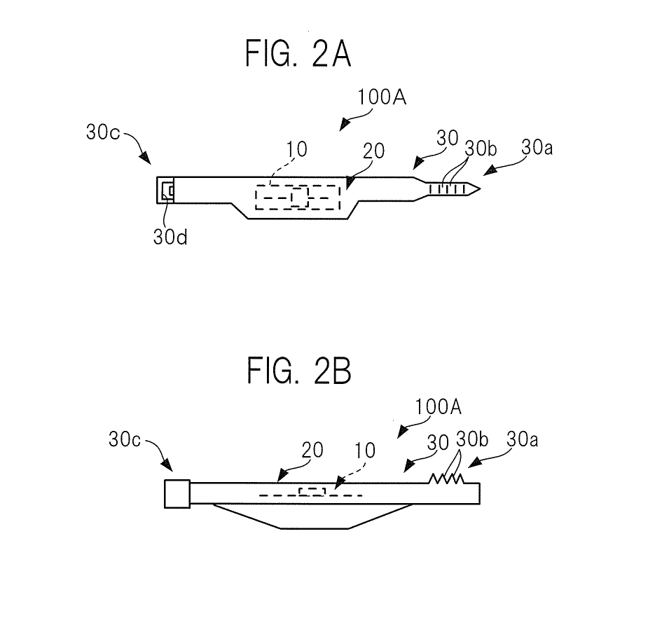

FIG. 2 illustrates a RFID tag of a first embodiment of the present invention. FIG. 2A is a plan view, whereas FIG. 2B is a side view.

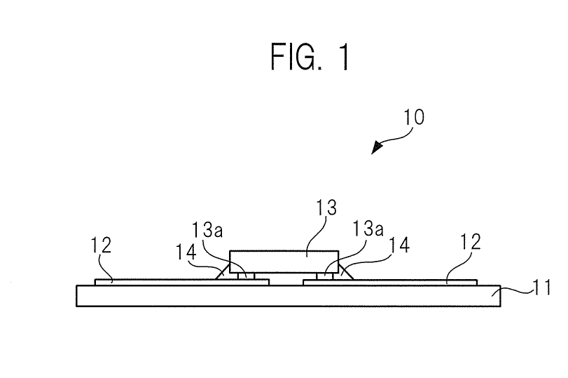

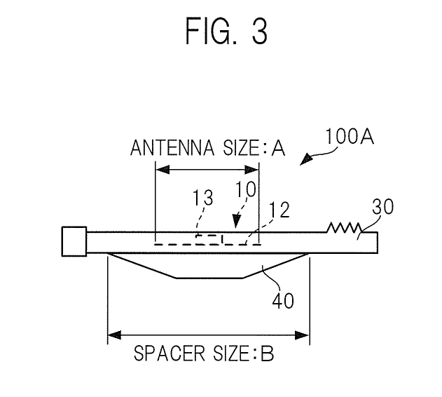

A RFID tag 100A is composed of an inlay 10 having an antenna 12 and a circuit chip 13 as illustrated in FIG. 1; an enclosure 20 for enclosing the inlay 10; a belt 30 that is integrally formed with the enclosure 20 and extends from the enclosure 20 in right and left directions in FIG. 2; and a spacer 40 that is fixed (here, adhered) to a surface of the enclosure 20 on an article 90 side (see FIG. 3).

The enclosure 20 and the belt 30 are made of a flexible material like rubber or plastic, and the inlay 10 is completely sealed in the enclosure 20. In one end 30a of the belt 30, notches 30b with bumps are formed, and on the other end 30C of the belt 30, a coupling section 30d having a through hole for letting through the one end 30a is formed.

The spacer 40 is a single continuous member and made of a material in the form of rubber that follows deformation.

FIG. 3 is a drawing for explaining dimensions of the RFID tag illustrated in FIG. 2.

Here, a size B of the spacer 40 in a longitudinal direction of the belt 30 (right and left directions in FIG. 3) is larger than a size A of the antenna 12 constituting the inlay 10 in the longitudinal direction of the belt 30. The spacer 40 is fixed to a position covering the antenna 12 with respect to the longitudinal direction of the belt 30.

Since the RFID tag 100A is provided with the spacer 40, a spacing from the article 90 (see FIG. 3) is securely maintained.

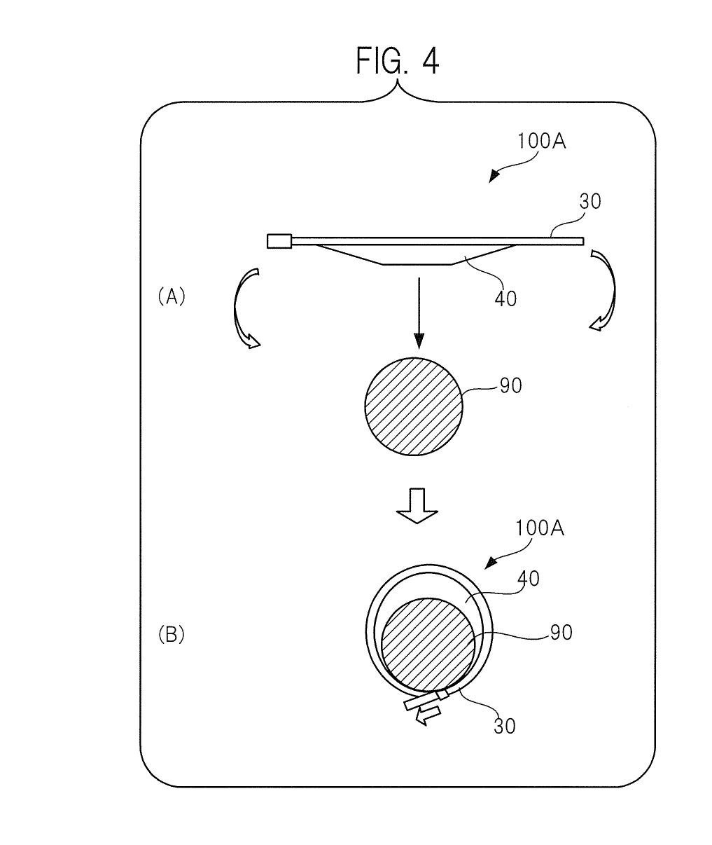

FIG. 4 is a drawing for explaining an attaching method of the RFID tag illustrated in FIG. 2.

As illustrated in part (A) of FIG. 4, the article 90 is wrapped around by the belt 30 while making the spacer 40 cover the article 90, then the one end 30a is inserted into the through hole in the coupling section 30d (see FIG. 2) to engage the notches 30b with bumps in the one end 30a with the through hole, and thus the RFID tag 100A is attached to the article 90 as illustrated in part (B) of FIG. 4.

At this time, the spacer 40 is deformed by being sandwiched between the belt 30 and the article 90, and maintains a spacing between the article 90 and the enclosure 20 (see FIG. 2).

At this time, if the antenna 12 constituting the inlay 10 is placed near metal, since the metal reflects electromagnetic waves and cancels incident light, so that an electromagnetic field near the metal becomes considerably feeble. Alternatively, if water is present near the antenna 12, since the water absorbs electromagnetic waves, so that an electromagnetic field near the water becomes considerably feeble as well. Therefore, if the article 90 is a metal pillar or a person's arm (high in water content), it is necessary to keep a distance from these by the spacer 40.

A thickness necessary for the spacer 40 will be considered.

Here, it is assumed that the antenna 12 is a half-wave dipole antenna. If a gain and an impedance of the dipole antenna in a free space are designated as Ga, Za, respectively, whereas a gain and an impedance of the dipole antenna are designated as Ga′, Za′, respectively when there is nearby a metal plane extending infinitely, and an impedance of the circuit chip 13 is designated as Zt, then a power supplied to a RFID tag in a free space is obtained as follows.

$$\begin{matrix}[ Formula 1 ] & \\ P = Ga \times {( \frac{Re [ Zt ] - Za}{Re [ Zt ] + Za} )}^{2} & ( 1 )\end{matrix}$$

The formula 1 calculates a power supplied to a RFID tag in a free space.

Subsequently, a power supplied to a RFID tag when metal is present is obtained as follows.

$$\begin{matrix}[ Formula 2 ] & \\ {P}^{′} = {Ga}^{′} \times {( \frac{Re [ Zt ] - {Za}^{′}}{Re [ Zt ] + {Za}^{′}} )}^{2} & ( 2 )\end{matrix}$$

The formula 2 calculates a power supplied to a RFID tag when metal is present.

A communication distance is determined by a power supplied to a RFID tag, and a change amount R in a communication distance when metal is present nearby is proportionate to the square root of a power.

$$\begin{matrix}[ Formula 3 ] & \\ R = \sqrt{\frac{{P}^{′}}{P}} & ( 3 )\end{matrix}$$

A change amount R is obtained by the above formula 3.

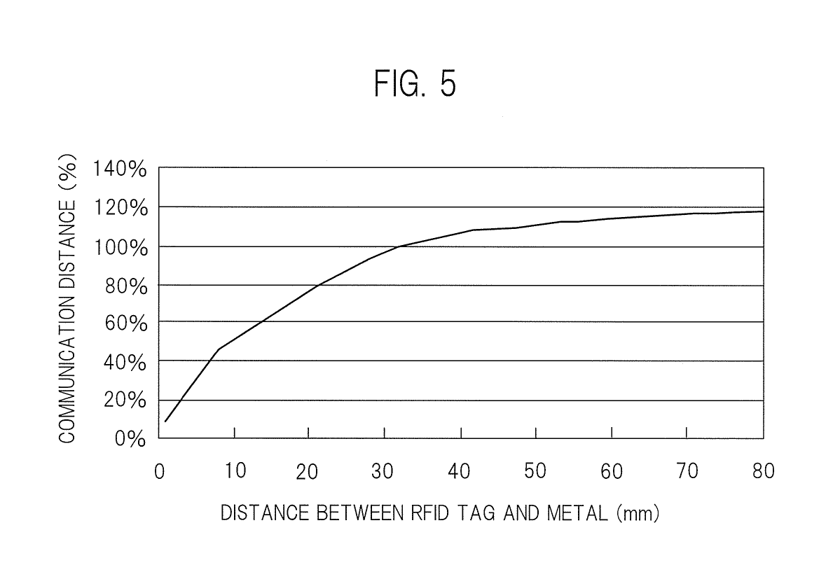

FIG. 5 is a drawing illustrating a spacing between metal and a RFID tag in UHF band using 953 MHz, and a communication distance of the RFID tag.

It is noted that when another frequency is used, a relationship is proportionate to a wavelength.

A relationship between a spacing of the metal and the RFID tag and a communication distance of the RFID tag, which is obtained by the above formulas presents gradual decrease in the communication distance up to 8 mm. However, a distance change rate becomes large in areas nearer than that.

That is, if a spacing between metal and a RFID tag is attained by only the thickness of a spacer, then in areas equal to or less than 8 mm, variations in the thickness of a spacer affect largely as variations in the communication distance and stable use is impaired. Therefore, using a spacer having a thickness of equal to or greater than 8 mm reduces influence of variations in the thickness of the spacer and is appropriate for attaching to metal. Alternatively, in practice, a spacer having a thickness of equal to or greater than 8 mm, in a thickness that is easily obtained (for example, 10 mm, 20 mm and so on) may be employed.

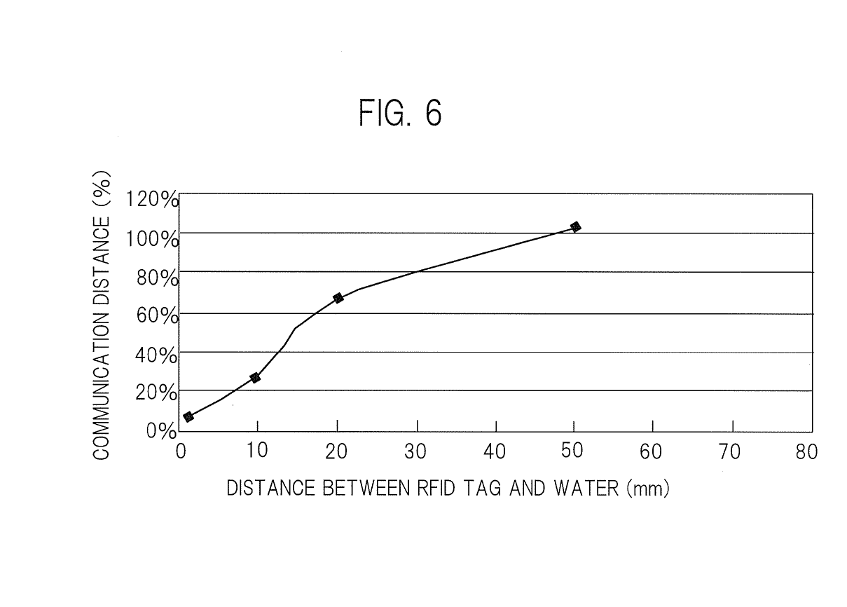

FIG. 6 is a drawing illustrating a spacing between water and a RFID tag in UHF band using 935 MHz, and a communication distance of the RFID tag, which is obtained in a similar manner.

Here, a half-wave dipole antenna is used and a communication distance is obtained by a similar calculation as that of metal, based on the assumption that a relative dielectric constant of water is 80.7; a dielectric loss tangent of water is 0.055; and a water tank has dimensions of 20 cm×20 cm×30 cm (depth).

A relationship between a spacing of the water and the RFID tag and a communication distance of the RFID tag, obtained by the above-description presents gradual decrease in the communication distance until when a spacer has a thickness of 18 mm. However, a distance change rate becomes large in areas thinner than that.

That is, if a spacing between water and a RFID tag is attained by only the thickness of a spacer, then in areas equal to or less than 18 mm, variations in the thickness of a spacer affects largely as variations in the communication distance and stable use is impaired. Therefore, using a spacer having a thickness of equal to or greater than 18 mm reduces influence of variations in the thickness of the spacer and is appropriate for attaching to an article that is presumably influenced by water. Alternatively, in practice, a spacer having a thickness of equal to or greater than 18 mm, in a thickness that is easily obtained (for example, 10 mm, 20 mm and so on) may be employed.

From the above consideration, in the RFID tag 100A of the present embodiment and also in various kinds of embodiments to be described later, when a metal pillar is supposed as the article 90, the thickness of the spacer 40 is defined to keep a spacing between the inlay 10 and the article 90 greater than or equal to 8 mm. Also, when an article that is high in water content like a person's arm is supposed as the article 90, the thickness of the spacer 40 is defined to keep a spacing between the inlay 10 and the article 90 greater than or equal to 18 mm.

The above descriptions are a basic embodiment of the RFID tag of the present invention and in the following, various kinds of embodiments of the RFID tag of the present invention will be described. In each drawing illustrating each embodiment, identical components as those of the RFID tag 100A in the first embodiment illustrated in FIG. 2 are referred to by same numerals as in FIG. 2, and explanation will be made about differences.

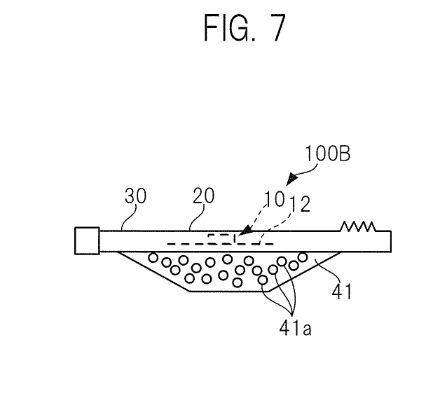

FIG. 7 illustrates a RFID tag of a second embodiment of the present invention.

Only a spacer 41 is different in a RFID tag 100B illustrated in FIG. 7 as compared to the RFID tag illustrated in FIG. 2. The spacer 41 of the RFID tag 100B illustrated in FIG. 7 is a single continuous member as a whole, made of a foam material in which bubbles are dispersed, for example, rubber foam.

In general, a rubber material has a large dielectric loss and is apt to lose energy of electromagnetic waves, so that a communication distance is short. As such, here, the spacer 41 is made of a foam material such as rubber foam, for allowing air to be present inside the spacer 41 to suppress reduction in a communication distance. Although a rubber material has a dielectric rate of substantially 3 to 5 in general, it is possible to reduce an actual dielectric rate substantially to 2 by having air in a part. This improves an antenna gain without downsizing the antenna 12 to the extent of unnecessary dimensions.

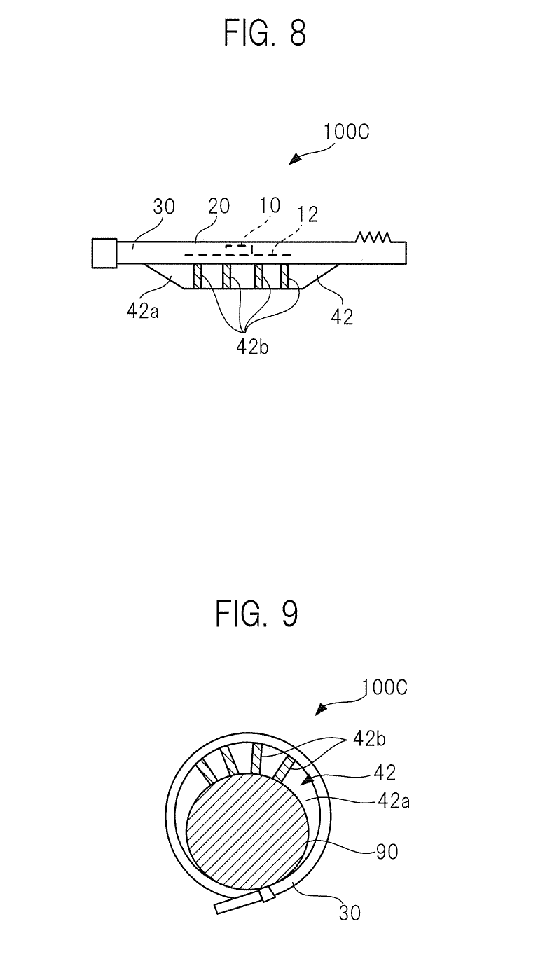

FIG. 8 illustrates a RFID tag of a third embodiment of the present invention, and FIG. 9 illustrates a state in which the RFID tag illustrated in FIG. 8 surrounds an article.

Also in a RFID tag 100C illustrated in FIG. 8, only a spacer 42 is different, as compared to the RFID tag 100A illustrated in FIG. 2. The spacer 42 of the RFID tag 100C illustrated in FIG. 8 is a single continuous member having a structure in which rigid members 42d made of a material such as plastic are dispersedly arranged in a flexible member 42a made of a material such as rubber. As such, when the RFID tag 100C surrounds the article 90, by the rigid members 42d dispersedly arranged in the spacer 42, a spacing between the antenna 12 constituting the inlay 10 and the article 90 is controlled irrespective of a wrapping strength of the belt 30, so that a predetermined antenna characteristics can be obtained.

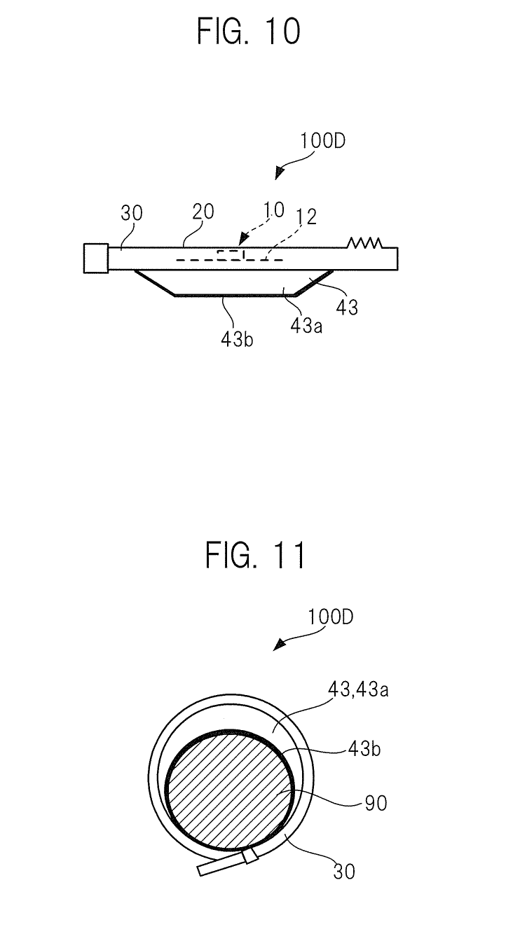

FIG. 10 illustrates a RFID tag of a fourth embodiment of the present invention, and FIG. 11 illustrates a state in which the RFID tag illustrated in FIG. 10 surrounds an article.

Also in a RFID tag 100D illustrated in FIG. 10, only a spacer 43 is different, as compared to the RFID tag 100A illustrated in FIG. 2. The spacer 43 of the RFID tag 100D illustrated in FIG. 10 includes an adhesive layer 43b for attaching to an article, on a surface of a base member 43a made of a flexible material such as rubber, on the article 90 side.

Therefore, when the RFID tag 100D is once wrapped around the article 90, the adhesive layer 43b adheres to the surface of the article 90, preventing detachment or displacement of an attaching position of the RFID tag 100D even if the belt 30 becomes loose more or less, so that a secure attachment is expected.

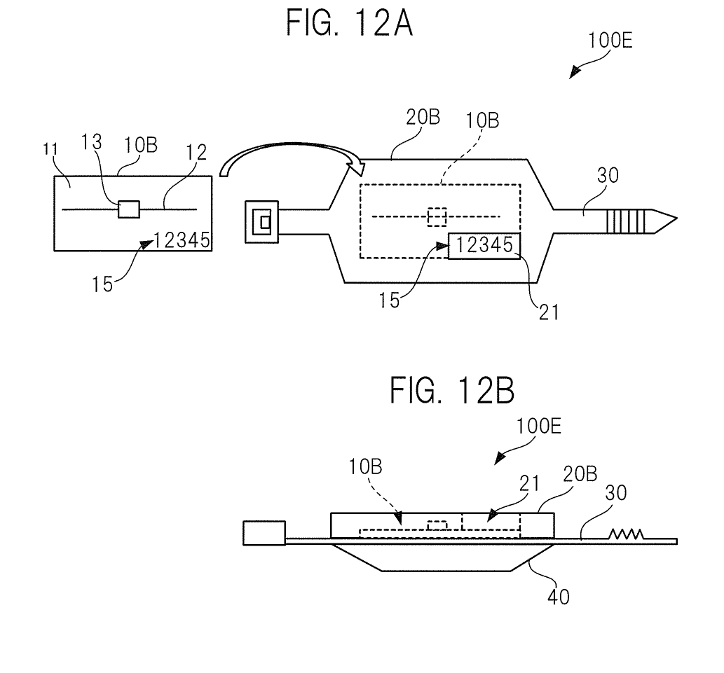

FIG. 12 illustrates a RFID tag of a fifth embodiment of the present invention. FIG. 12A is a plan view of the RFID tag and an inlay on the side, whereas FIG. 12B is a side view of the RFID tag.

An inlay 10B constituting a RFID tag 100E illustrated in FIG. 12 further includes a piece of visible information (here, numbers “12345”) printed on its antenna base 11, as compared to the inlay 10 explained with reference to FIG. 1.

An enclosure 20B constituting the RFID tag 100E illustrated in FIG. 12 encloses the inlay 10B on which the visible information is printed. The enclosure 20B includes a view window 21 made of a transparent material for viewing a piece of visible information printed on the enclosed inlay 10B.

If this structure is employed, a failure that a piece of visible information on the inlay 10B fades or disappears is prevented.

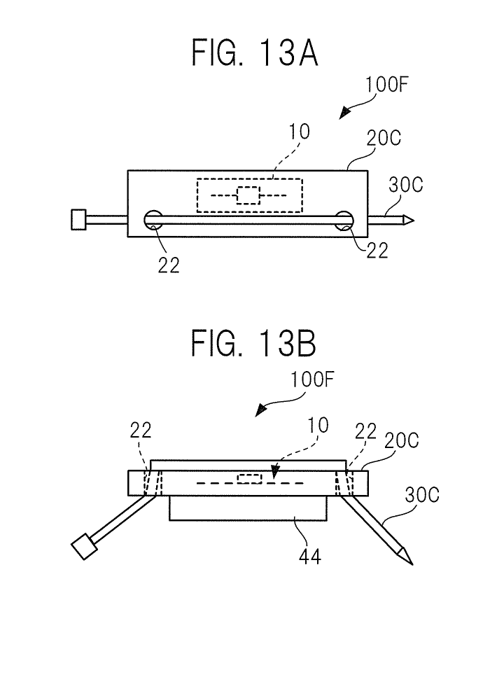

FIG. 13 illustrates a RFID tag of a sixth embodiment of the present invention. FIG. 13A is a plan view, whereas FIG. 13B is a side view. In a RFID tag 100F illustrated in FIG. 13, a belt 30C is formed separately from an enclosure 20C. In the enclosure 20C, belt through holes 22 are formed and the belt 30C is attached to the enclosure 20C by being inserted into the belt through holes 22. The RFID tag 100F is attached to an article (illustration is omitted here) while the belt 30C still being inserted in the belt through holes 22.

In FIG. 13, although a spacer 44 has a different cross-sectional shape as compared to the spacer 40 of the RFID tag 100A illustrated in FIG. 2, the spacer 44 is made of a single continuous member of a flexible material.

As illustrated in FIG. 13, if the belt 30C is prepared separately from the enclosure 20C, it is possible to use a same enclosure regardless of dimensions of an article, by preparing only belts having different lengths according to dimensions of an article.

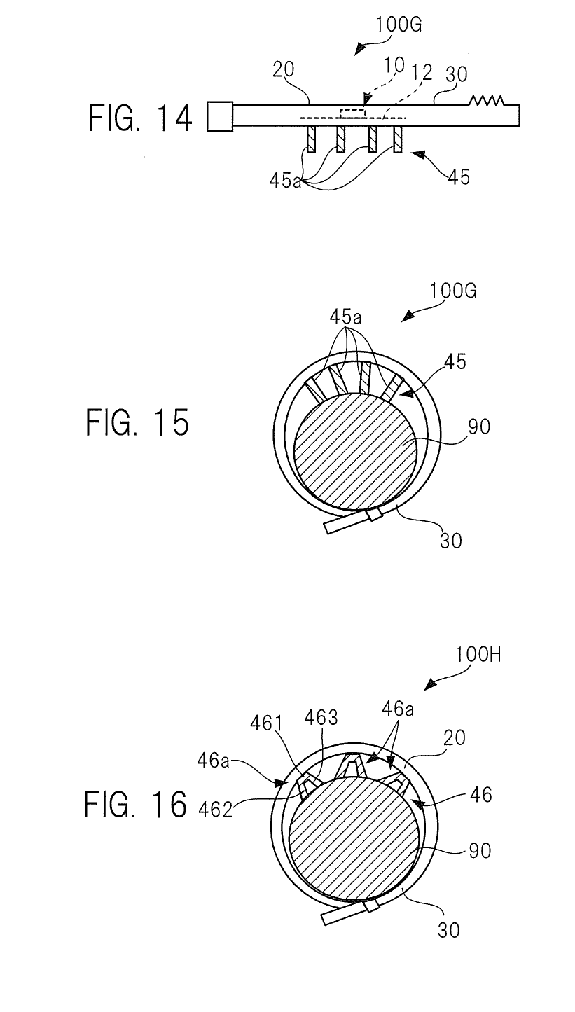

FIG. 14 illustrates a RFID tag of a seventh embodiment of the present invention. FIG. 15 illustrates a state in which the RFID tag illustrated in FIG. 14 surrounds an article.

Although the above-described RFID tags 100A to 100F in various kinds of embodiments include a spacer made of a single continuous member, a RFID tag 100G illustrated in FIG. 14 is different from those RFID tags and includes a spacer 45 made up of plural space maintaining members 45a each arranged spaced apart in a longitudinal direction of the belt 30. Each of the space maintaining members 45a is small enough compared to a size of the antenna 12 in a longitudinal direction of the belt, allowing attachment even to a column-shaped article.

The space maintaining members 45a constituting the spacer 45 are made of a rigid material such as plastic and change relative postures with respect to one another according to deformation of the belt 30 when the belt 30 is wrapped around the article 30 or the like, so that the spacer 45 deforms as a whole. Therefore, when the RFID tag 100G surrounds the article 90 as illustrated in FIG. 15, each of the space maintaining members 45a constituting the spacer 45 takes a posture fitting to the deformation of the belt 30 and a surface shape of the article 90. And thus the spacer 45 composed of the space maintaining members 45a maintains a spacing between the enclosure 20 and the article 90 to be a spacing controlled by a length of the space maintaining members 45a.

As such, a spacer in the RFID tags of the present invention is not limited to a single continuous member, but may be composed of plural space maintaining members arranged in the longitudinal direction of the belt, like the one illustrated in FIGS. 14 and 15.

FIG. 16 illustrates a state in which the RFID tag of the eighth embodiment surrounds an article.

Here, a difference from the RFID tag 100G of the seventh embodiment illustrated in FIGS. 14 and 15 will be explained.

As compared to the RFID tag 100G illustrated in FIG. 14, only a shape of a spacer 46 is different in a RFID tag 100H illustrated in FIG. 16.

The spacer 46 of the RFID tag 100H illustrated in FIG. 16 is composed of space maintaining members 46a made of a rigid material such as plastic, arranged spaced apart in the longitudinal direction of the belt 30, in a similar manner to the spacer 45 of the RFID tag 100G illustrated in FIGS. 14 and 15. However, as compared to the spacer 45 of the RFID tag 100G illustrated in FIGS. 14 and 15, a shape of the space maintaining members 46a is different. Each of the space maintaining members 46a has a shape including a base section 461 fixed to the enclosure 20 for enclosing an inlay (not illustrated here), and a pair of standing sections 462, 463 of the base section 461, standing with respect to the enclosure 20 and bifurcating into two branches, from both ends in the longitudinal direction of the belt 30, in the longitudinal direction of the belt 30 while widening a gap between the two branches.

In this way, since the spacer 46 of the RFID tag 100H is composed of the plural space maintaining members 46a having a shape of open bifurcated branches, namely, a shape of trapezoid with legs, the space maintaining members have enhanced stability and thus resist falling off. Alternatively, when stability of the space maintaining members 46a is enhanced by enlarging a dimension of the space maintaining members 46a in the longitudinal direction of the belt, a capability of accommodating a surface shape of the article 90 is not lost and the space maintaining member 46a takes a flexible posture fitting to the surface shape of the article 90.

Next, a manufacturing method of a RFID tag will be explained.

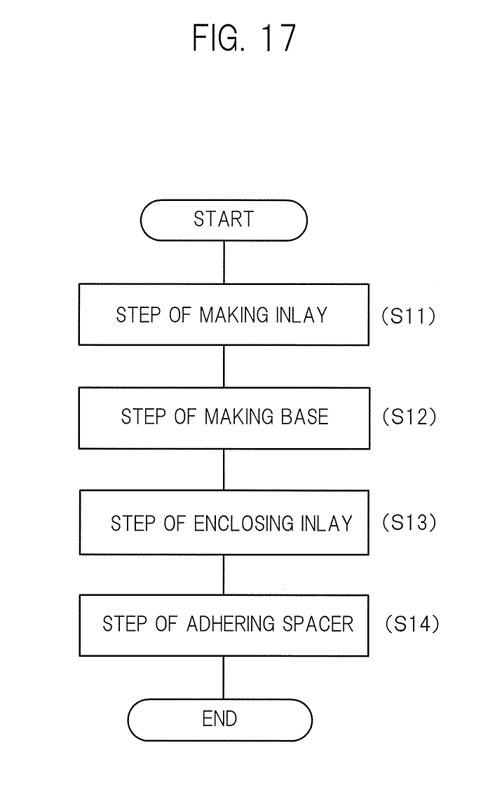

FIG. 17 is a flowchart illustrating one embodiment of a manufacturing method of a RFID tag of the present invention.

Here, a RFID tag that is one embodiment of the present invention is manufactured through the steps of making an inlay (step S11), making a base (step S12), enclosing an inlay (step S13), and adhering a spacer (step S14).

Hereafter, each step (step S11 to S14) will be explained.

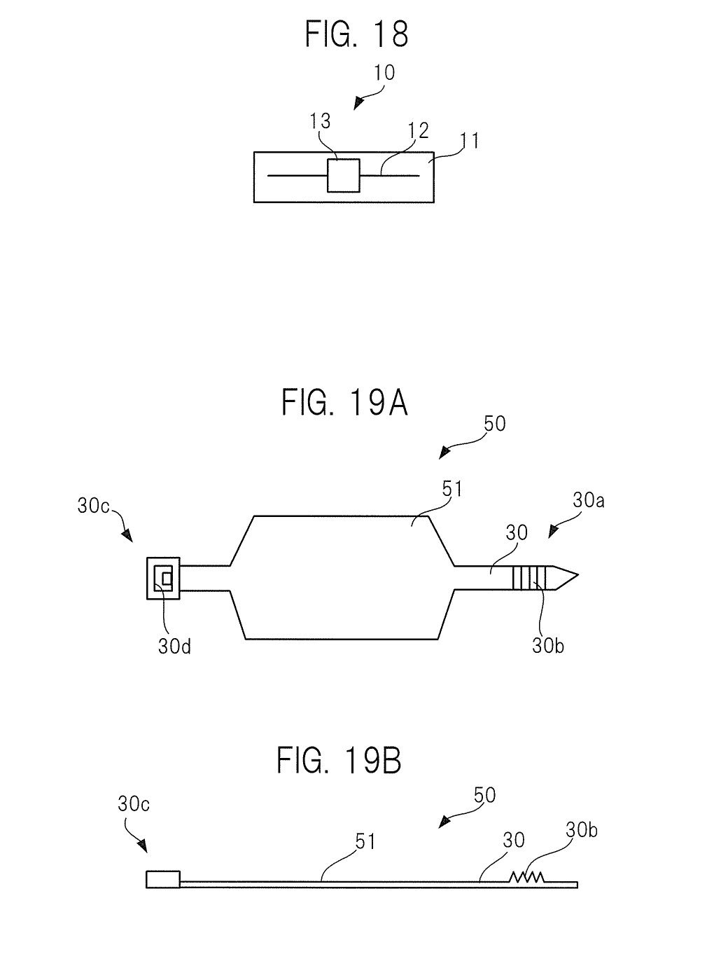

FIG. 18 is a drawing for explaining a step of making an inlay (step S11).

In this step, the inlay 10 is made by forming the antenna 12 on the antenna base 11, and further mounting thereon the circuit chip 13 incorporating a communication circuit for wireless communications by using the antenna 12.

FIG. 19 is a drawing for explaining a step of making a base (step S12). FIG. 19A is a plan view of the base, whereas FIG. 19B is a side view of the base.

A base 50 is made by molding silicon rubber or the like and includes an inlay placement section 51 for placing the inlay 10 (see FIG. 18) in a center and portions to be used as a belt (here, referred to as the belt 30) after completion of the RFID tag extend from both sides of the inlay placement section 51.

In one end 30a of the belt 30, notches 30b with bumps are formed, and on the other end 30c of the belt 30, a coupling section 30d having a through hole for inserting the one end 30a is formed.

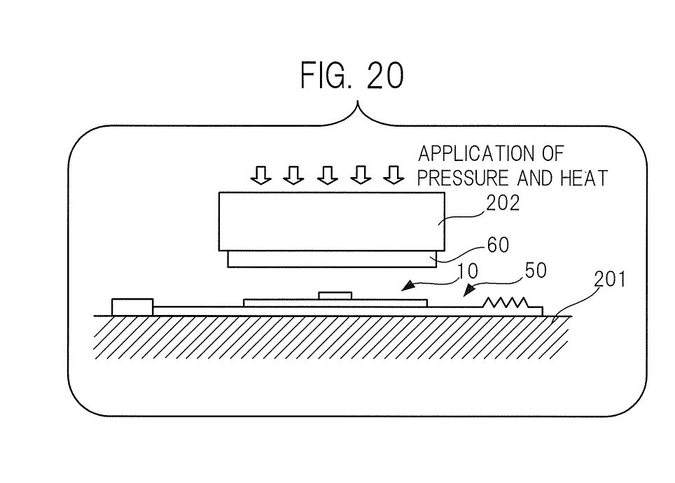

FIG. 20 is a drawing for explaining a step of enclosing an inlay.

On a heat and pressure application stage 201, the base 50 illustrated in FIG. 19 is placed, and the inlay 10 illustrated in FIG. 18 is placed in the inlay placement section 51 (see FIG. 19) of the base 50. Further, a cover 60 made of a same material as the base 50, separately formed, having a same shape as that of the inlay placement section 51 of the base 50 is placed thereon, and these are sandwiched by the heat and pressure application stage 201 and a heat and pressure application head 202 for thermo-compression bonding by the application of heat and pressure.

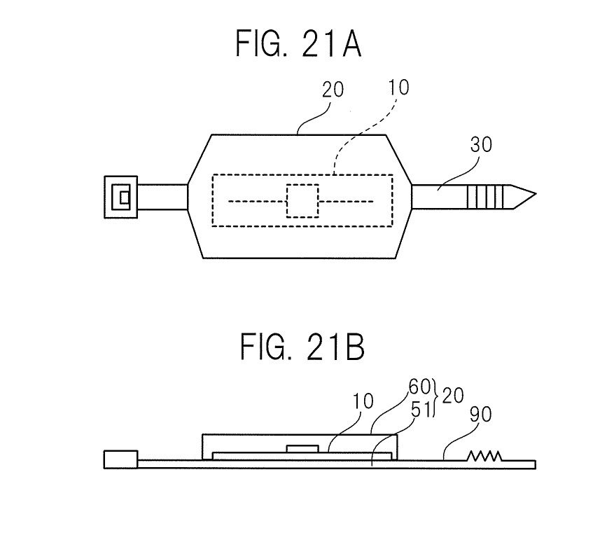

FIG. 21 illustrates a shape after thermo-compression bonding.

By the thermo-compression bonding in the step of enclosing an inlay (step S13), the inlay placement section 51 of the base 5 and the cover 60 are thermally bonded and the enclosure 20 is formed with the inlay 10 completely shielded in the enclosure 20.

Additionally, in FIG. 21, although a line is drawn between the base 50 and the cover 60 as if indicating that these are separate parts, this line is drawn for easier understanding and in actuality, these are completely bonded to be a seamless single state by the thermo-compression bonding.

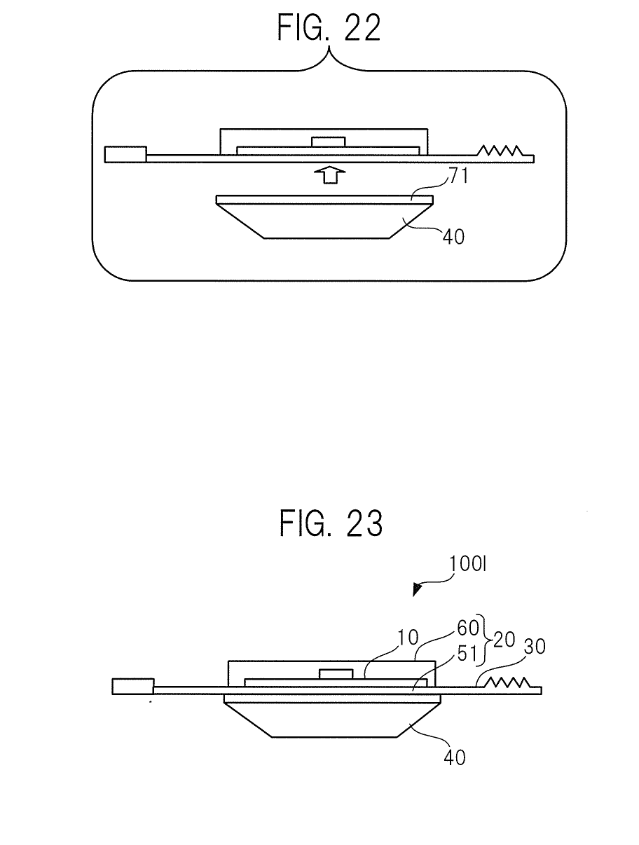

FIG. 22 is a drawing for explaining a step of adhering a spacer (step S14), and FIG. 23 illustrates a completed RFID tag after the spacer is adhered.

By the thermo-compression bonding illustrated in FIG. 20, the RFID tag becomes a state as illustrated in FIG. 21, thereafter the separately formed spacer 40 is bonded to a base 50 by a double-faced adhesive 71, and thus a RFID tag 100I that is substantially similar to the RFID tag in FIG. 2 is completed, as illustrated in FIG. 23.

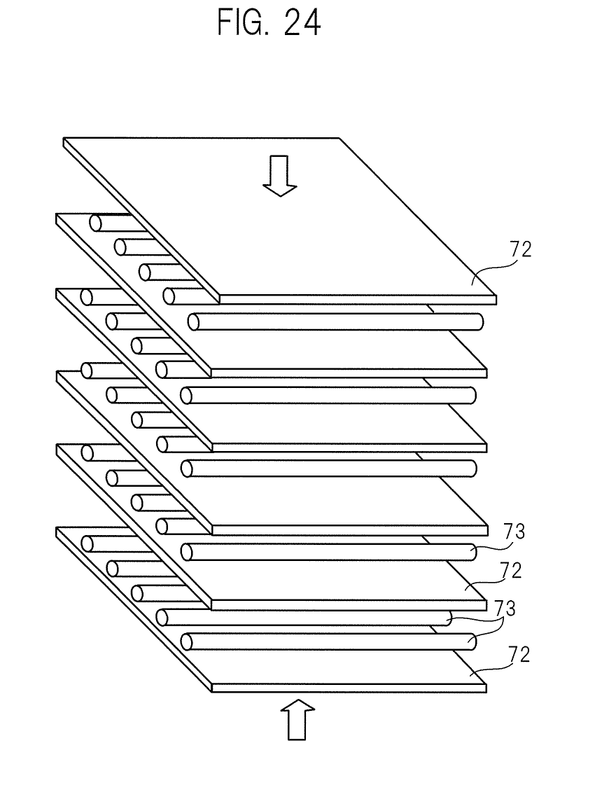

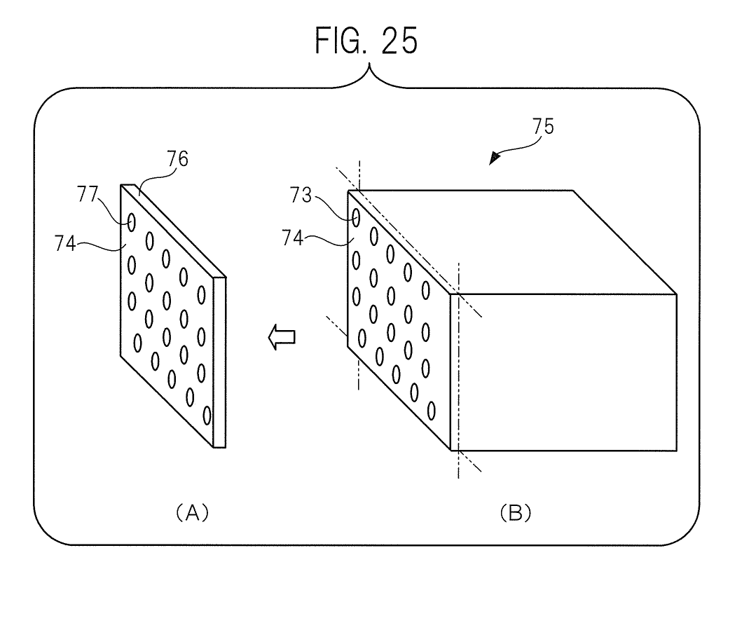

FIGS. 24, 25 are drawings for explaining a manufacturing method of a spacer.

A manufacturing method illustrated in FIGS. 17 to 23 is a manufacturing method based on the use of the spacer 40 made of a uniform material, for example, such as rubber. However, a spacer that is manufactured by an after-mentioned manufacturing method may be employed in place of the spacer 40 made of such a uniform material.

FIG. 24 illustrates a multilayer state in which a sheet member 72 made of a flexible material such as rubber and plural line members 73 made of a rigid material such as plastic that are arranged spaced apart on the sheet member 72 are stacked in layers.

The sheet member 72 and the plural line members 73 are stacked alternately in layers as illustrated in FIG. 24, and the entire lamination is sandwiched by the heat and pressure application stage 201 and the heat and pressure application head 202 for thermo-compression bonding to bond the sheet members 72 thermally, for example, as illustrated in FIG. 20.

FIG. 25 illustrates a block (B) that is formed by bonding base members thermally, and a sheet member (A) that is cut out from the block.

As illustrated in FIG. 24, when the sheet member 72 and the plural line members 73 are stacked alternately in layers and then the sheet members 72 are bonded thermally, then a block 75 is formed in which line members 73 made of a rigid material such as plastic are dispersedly arranged in two dimensions in a flexible member 74 made of rubber or the like, as illustrated in part (B) of FIG. 25.

From this block 75, as illustrated in part (A) of FIG. 25, a sheet member is cut out in a thickness necessary for using as a spacer, and thus the sheet member 76 in which rigid members 77 are dispersedly arranged in the flexible member 74 is obtained.

By employing this sheet member 76, a RFID tag that can control a spacing precisely between an enclosure and an article, which has been explained with reference to FIGS. 8, 9 is completed.

In the manufacturing method of a RFID tag illustrated in FIG. 17, a spacer that is made in the step of making a spacer, which has been explained with reference to FIGS. 24, 25 may be employed.

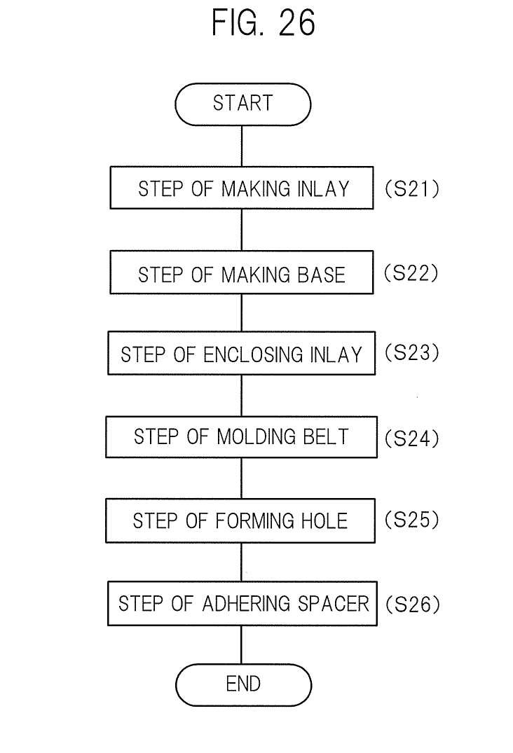

FIG. 26 is a flowchart illustrating another example of a manufacturing method of a RFID tag of the present invention.

Here, a RFID tag is manufactured through the steps of making an inlay (step S21), making a base (step S22), enclosing an inlay (step S23), molding a belt (step S24), forming a hole (step S25), and adhering a spacer (step S26).

Hereafter, each step (step S21 to S26) will be explained.

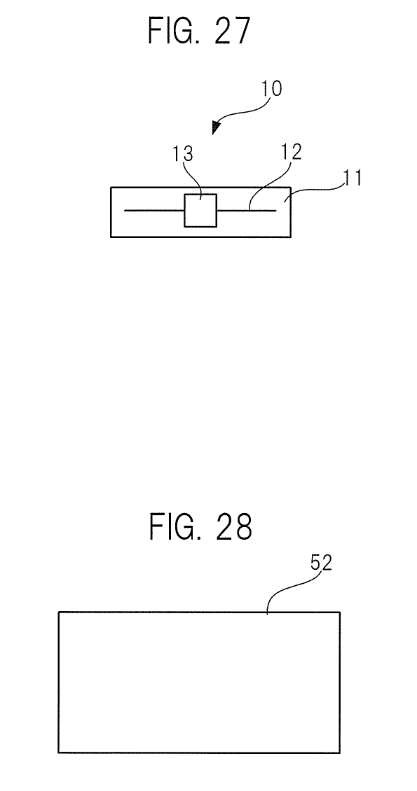

FIG. 27 is a drawing for explaining a step of making an inlay (step S21).

In this step as well, the inlay 10 is made by forming the antenna 12 on the antenna base 11, and further mounting the circuit chip 13 incorporating a communication circuit for wireless communications by using the antenna 12, on the antenna base 11.

FIG. 28 is a drawing for explaining a step of making a base (step S22).

Here, silicon rubber or the like is molded to make a base 52 composed of only an inlay placement section for placing the inlay 10.

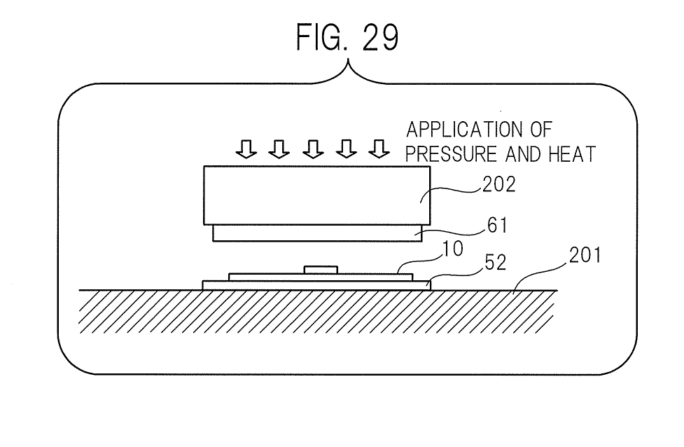

FIG. 29 is a drawing for explaining a step of enclosing an inlay (step S23).

The base 52 illustrated in FIG. 28 is placed on the heat and pressure application stage 201; the inlay 10 illustrated in FIG. 27 is placed on the base 52; and further, a cover 61 formed separately, having a same shape as that of the base 52, made of a same material as the base 52 is placed thereon; and these are sandwiched by the heat and pressure application stage 201 and the heat and pressure application head 202 for thermo-compression bonding by the application of heat and pressure.

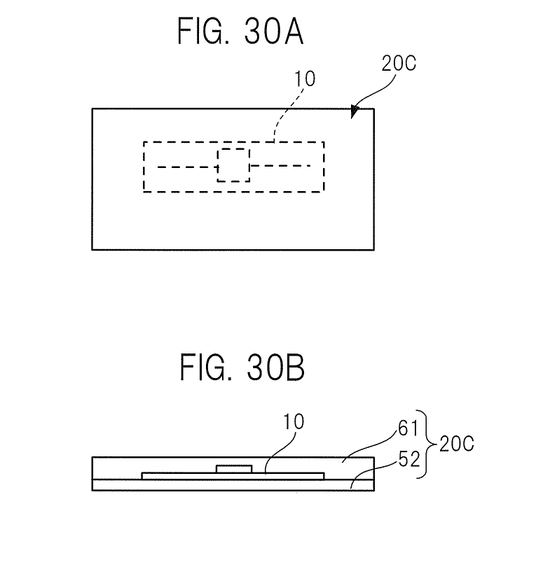

FIG. 30 illustrates a shape after the thermo-compression bonding.

By the thermo-compression bonding in the step of enclosing an inlay (step S23), the base 52 and the cover 61 are thermally bonded and thus the enclosure 20C is formed with the inlay 10 completely shielded in the enclosure 20C.

Additionally, also in FIG. 30, similarly in FIG. 21, although a line is drawn between the base 52 and the cover 61 as if indicating that these are separate parts, this line is drawn for easier understanding and in actuality, these are completely bonded to be a seamless single state by the thermo-compression bonding.

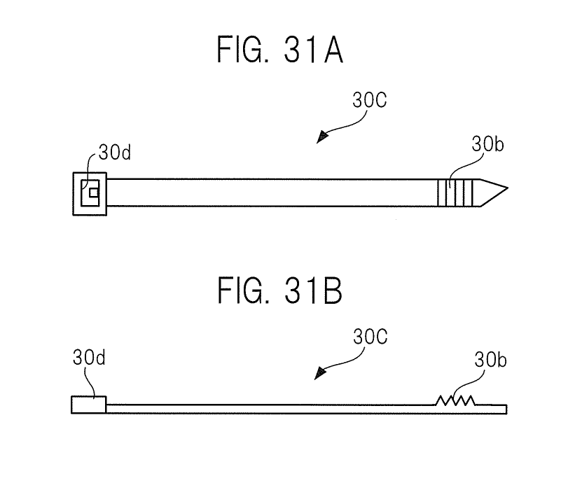

FIG. 31A is a plan view of a belt, whereas FIG. 31B is a side view of a belt.

Here, the belt 30C is molded of nylon or silicon rubber and so on, separately from the enclosure 20C illustrated in FIG. 30.

The belt 30C has notches 30b in one end and a coupling section 30d on the other end, which is same as a belt that is integrally formed with the inlay placement section (see FIG. 19).

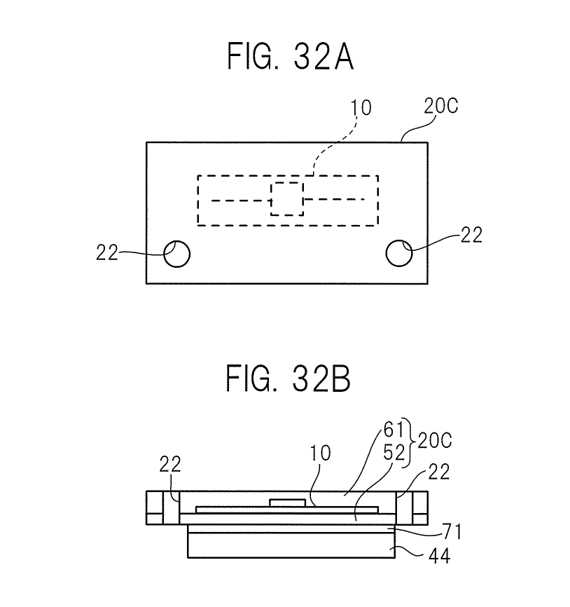

FIG. 32 is a drawing for explaining a step of forming a hole (step S25) and a step of adhering a spacer (step S26).

In the enclosure 20C that is formed as illustrated in FIG. 30, by the thermo-compression bonding illustrated in FIG. 29, the through holes 22 for letting through the belt 30C illustrated in FIG. 31 are formed, and furthermore, the spacer 44 is bonded to the enclosure 20C by the double-faced adhesive 71.

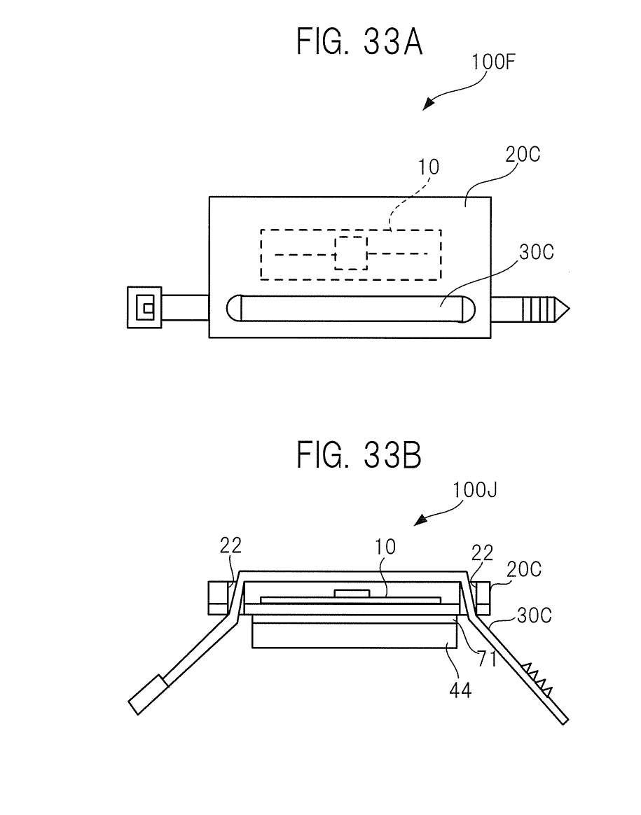

FIG. 33 illustrates a completed RFID tag. FIG. 33A is a plan view, whereas FIG. 33B is a side view.

FIG. 33 illustrates the enclosure 20C in a state illustrated in FIG. 32, that is, a state in which the belt 30C illustrated in FIG. 31 is attached to the enclosure 20C after the through holes 22 are formed and the spacer 44 is attached.

Through the above-described manufacturing steps, a RFID tag 100J of a type providing a belt separately is completed, which is similar to the RFID tag in FIG. 13.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A RFID tag comprising:
an inlay having an antenna and a circuit chip incorporating a communication circuit for wireless communications via the antenna;
an enclosure that encloses the inlay;
a flexible belt surrounding an article to attach the enclosure to the article; and
a spacer fixed to a surface of the enclosure on the article side, and deforming in response to deformation of the belt to maintain a spacing between the article and the enclosure.

2. The RFIG tag according to claim 1, wherein the belt is integrally formed with the enclosure.

3. The RFIG tag according to claim 1, wherein the belt is formed separately from the enclosure and detachably attached to the enclosure.

4. The RFIG tag according to claim 3, wherein the enclosure includes a hole to let through the belt and the belt is attached to the enclosure by being inserted into the hole.

5. The RFIG tag according to claim 1, wherein the inlay includes visible information recorded in a part of a surface of the inlay, and the enclosure includes a view window made of a material having light transmission characteristics to recognize the visible information.

6. The RFIG tag according to claim 1, wherein the spacer is a single continuous member having flexibility.

7. The RFIG tag according to claim 1, wherein the spacer is made up of a plurality of space maintaining members that are disposed spaced apart in a longitudinal direction of the belt and that change shape as a whole by changing postures in response to deformation of the belt.

8. The RFIG tag according to claim 6, wherein the spacer is made of a foam material in which bubbles are dispersed.

9. The RFIG tag according to claim 6, wherein a dimension of the spacer is larger than that of the antenna with respect to a longitudinal direction of the belt and the spacer is fixed to a position covering the antenna.

10. The RFIG tag according to claim 6, wherein the spacer is formed such that rigid members to maintain a spacing between the enclosure and an article are dispersedly arranged in a flexible member.

11. The RFIG tag according to claim 6, wherein the spacer includes an adhesion layer to adhere to an article, on a surface on the article side.

12. The RFIG tag according to claim 7, wherein each of the plurality of space maintaining members forming the spacer includes a base section fixed to the enclosure and a pair of standing sections standing with respect to the enclosure and bifurcating from the base section into two branches in the longitudinal direction of the belt while widening a gap between the two branches.

13. A manufacturing method of a RFID tag, the method comprising:
making an inlay by mounting, on an antenna base on which an antenna is formed, a circuit chip incorporating a communication circuit for wireless communications via the antenna;
making a base including an inlay placement section in which the inlay is placed and a belt section extending from the inlay placement section and surrounding an article to be fixed to the article;
enclosing the inlay by placing the inlay in the inlay placement section of the base, further placing a cover such that the inlay is sandwiched between the cover and the base, and applying heat and pressure, so that an enclosure that encloses the inlay by the base and the cover is formed on the base; and
adhering a spacer that maintains a spacing between the article and the enclosure on a surface of the enclosure on the article side.

14. A manufacturing method of a RFID tag, the method comprising:
making an inlay by mounting, on an antenna base on which an antenna is formed, a circuit chip incorporating a communication circuit for wireless communications via the antenna;
making a base on which the inlay is placed;
enclosing the inlay by placing the inlay in the inlay placement section of the base, further placing a cover such that the inlay is sandwiched between the cover and the base, and applying heat and pressure, so that an enclosure that encloses the inlay by the base and the cover is formed on the base;
molding a belt surrounding an article to attach the enclosure to the article;
forming a hole to let through the belt in the enclosure; and
adhering a spacer that maintains a spacing between the article and the enclosure on a surface of the enclosure on the article side.

15. The manufacturing method of a RFID tag according to claim 13, further comprising:
making a spacer in which rigid members are dispersedly arranged in a flexible material, by alternately laminating a sheet member made of a flexible material and a plurality of line members made of a rigid material, which are arranged spaced apart on the sheet member, and by forming a block in which the line members are dispersedly arranged in the flexible material through application of heat and pressure, and then by cutting the block in a predetermined thickness,
wherein the adhering of a spacer adheres the spacer that is made in the making of a spacer.

16. The manufacturing method of a RFID tag according to claim 14, further comprising:
making a spacer in which rigid members are dispersedly arranged in a flexible material, by alternately laminating a sheet member made of a flexible material and a plurality of line members made of a rigid material, which are arranged spaced apart on the sheet member, and by forming a block in which the line members are dispersedly arranged in the flexible material through application of heat and pressure, and then by cutting the block in a predetermined thickness,
wherein the adhering of a spacer adheres the spacer that is made in the making of a spacer.
